(19) United States
(12) Patent Application Publication
(10) Pub. No.: US 2002/0175492 A1
(43) Pub. Date: Nov. 28, 2002

(54) Wheeled platform for constructing task performing machines

(76) Inventor: Leslie Van Ornum, Hortonville, WI (US)

Correspondence Address: Russell L. Johnson, P.O. Box 161, Weyauwega, WI, 54983, US

(21) Appl. No.: 09/832,412

(22) Filed: Apr. 12, 2001

(51) Int. Cl. B60F 1/00

(52) U.S. Cl. 280/415.1; 280/420

(57) ABSTRACT

The invention is for a wheeled platform on which components can be assembled to create architectures for task performing machines. The major components of a machine assembled on the wheeled platform are a propulsion component, a power supply component, and a task-performing component. Articulation between the components is provided by means of interfaces, and a coupling attachment is provided for linking controls and utilities between the components.

### BACKGROUND OF THE INVENTION

1. Field of the Invention

This invention relates to powered attachments and a means for coupling them to propulsion vehicles.

More specifically, this invention relates to a wheeled platform on which a powered attachment's architecture is constructed.

Still more specifically, this invention relates to the platform described above wherein the platform is provided with multiple transition means for interfacing the platform with a propulsion vehicle, a power supply, and a utility attachment and associated means.

The architectures of a large number of utilitarian machines comprise a power means, a propulsion means, and a means for performing a task. When the three functions are grouped together to provide a self-propelled unit such as a corn picker or a road grader the architecture is specific the task performed. In other instances the power supply and the propulsion means are a unit and the task performing means is provided as an attachment to the propulsion means. Garden tractors and skid steerers are examples of such architecture. In still other instances, the power means and the task-performing means are a unit and the propulsion means is a separate means. Walk-behind grass mowers and roto-tillers are examples of that architecture.

In most instances the motor or other power supply is the most costly component of a utilitarian machine. Frequently, one user will own several task-performing machines that have nearly the same size motor. It would be desirable to have just one power source for all of the task performing means to be employed by the user.

It is therefore an object of this invention to provide a wheeled platform having means for attaching a variety of power supplies to the platform.

It is further an object of this invention to provide the wheeled platform described above wherein the platform is provided with a means for attaching a variety of task performing attachments.

It is further an object of this invention to provide the above described wheeled platform wherein the platform is provided with a means for coupling the platform to a propulsion vehicle.

It is still further an object of this invention to provide the above described wheeled platform wherein the platform is provided with a means for coupling the platform to a utilities coupling means.

Other objects will be made apparent by the following specifications, drawings and claims.

2. Description of the Related Art

The prior art abounds with task performing attachments to vehicles. The prior art abounds with self-propelled task performing machines. The art abounds with task performing powered machines that are pushed by hand.

The art has not heretofore provided a wheeled platform on which a power source could be mounted, and to which a propulsion vehicle could be attached, and to which a task performing attachment could be attached and the power source is operably connected to the task performing attachment to form a mobile task performing machine.

The problem solved by this invention is one faced by park departments, landscapers, golf courses and the like. It is one involving the need to purchase a significant number of propulsion means, power sources, and task performing means in order to accomplish the diverse tasks which they are called upon to perform. Maintenance and storage of a large number of redundant power sources, propulsion means, and task-performing means is a continuous problem for people who maintain large areas of landscaped and/or paved land.

### BRIEF SUMMARY OF THE INVENTION

This invention is a wheeled platform for constructing a mobile task-performing machine. The platform comprises; elongate beam having a first end and a second end and a central platform secured to the beam; a means for securing depending wheels near the first and second ends of the beam; and, means for securing components of a task performing machine to the platform and the beam, and at least one of the components is a propulsion means, and at least one of the components is a task performing powered apparatus, and at least one of the components is a power source.

### BRIEF DESCRIPTION OF THE DRAWINGS

FIG. 1 is a schematic exploded pictorial view of the platform of this invention illustrating the relationship between the platform and the components of a machine constructed on the platform.

FIG. 2 is a schematic elevational view showing the relationship between the wheeled platform, the interfaces and the components shown in FIG. 1

FIG. 3 is a pictorial view of the platform of this invention with the interfaces of FIGS. 1 and 2 attached.

### DETAILED DESCRIPTION OF THE INVENTION

In the drawings like numbers refer to like objects and the proportions of some elements have been changed to facilitate illustration and numerous non-critical aspects of the invention have not been shown to simplify disclosure of the inventive concepts and to facilitate understanding of their relationship to the prior art.

As used herein, the “term” roll shall be read to mean rotation about a longitudinal horizontal axis, the term “pitch” shall be read to mean rotation about a horizontal axis that is normal to the roll axis, and the term “yaw” shall be read to mean rotation about a vertical axis.

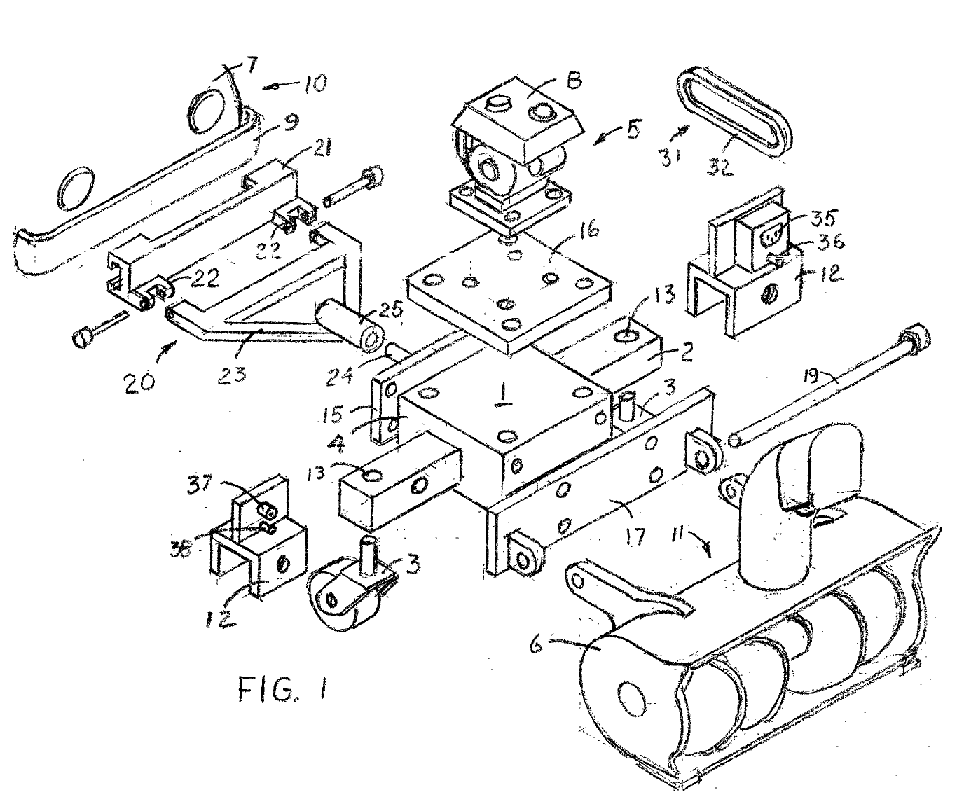

Referring now to FIG. 1 wherein wheeled platform 1 and its relationship to components of a mobile machine mounted thereon is illustrated. Wheeled platform 1 has beam 2 having mountings for wheels 3 near its ends and a central mounting platform 4 secured to the midsection of beam 2.

Wheeled platform 1 provides a mobile platform on which a task performing machine can be assembled and to which a propulsion means can be coupled and on which a power source can be mounted. The architecture of the assembled machine can be as diverse as the platform can accommodate.

In FIG. 1 Wheeled platform 1 is coupled to propulsion means 10, which is vehicle 7, and has mounted thereon power source 5, which is engine 8, and has attached thereto task performing attachment 11 which is a snow blower 6. Wheeled platform 1 is provided with means for attaching the interfaces to the platform and the interfaces in turn are provided with a means for coupling the peripherals to the interfaces. Propulsion means interface 15 serves to couple propulsion means 10 to platform 1. Power source interface 16 serves to couple power source 5 to platform 1. Task performing attachment interface 17 serves to couple task performing attachment 17 to platform 1.

The platform of this invention has aspects in common with a computer in that it serves as a platform on which a task performing architecture can be constructed by employing interfaces to couple peripheral components to the platform to provide an interactive task performing mechanism. Just as a computer can perform an almost unlimited number of tasks using an array of attachments and interfaces, so too can the platform of this invention.

The following lists of attachments, power supplies, and propulsion means are representative of the peripheral components that can be interfaced with the platform of this invention or attached directly to it.

ATTACHMENTS

| | |
|---|---|
| Mowers | Cycle bars |
| Tillers | Aerators |
| Trenchers | Augers |
| Blades | Sweepers |
| Shredders | Chippers |
| Saws | Splitters |
| Pumps | Culvert Cleaners |
| Mulchers | Generators |
| Edgers | Buckets |
| Snow Blowers | Leaf Blower |
| Rakes | Scoops |
| Sprayers | |

POWER SUPPLIES

| | |
|---|---|
| Gasoline Engines | Electric Motors |
| Hydraulic Motors | Hydraulic Pumps |
| Diesel Motors | Pneumatic Motors |
| Pneumatic Pumps | Generators |

PROPULSION MEANS

| | |
|---|---|
| Cars | Trucks |
| Tractors | Garden Tractors |
| Riding Mowers | All Terrain Vehicles |
| Golf Carts | Crawlers |
| Skid Steerers | |

From the above lists it is clear that the combinations of components that can be coupled to the wheeled platform of this invention is large and diverse. The inventor has chosen to present one combination of components to be representative of the concepts of his invention and with which to disclose the novel features of his invention.

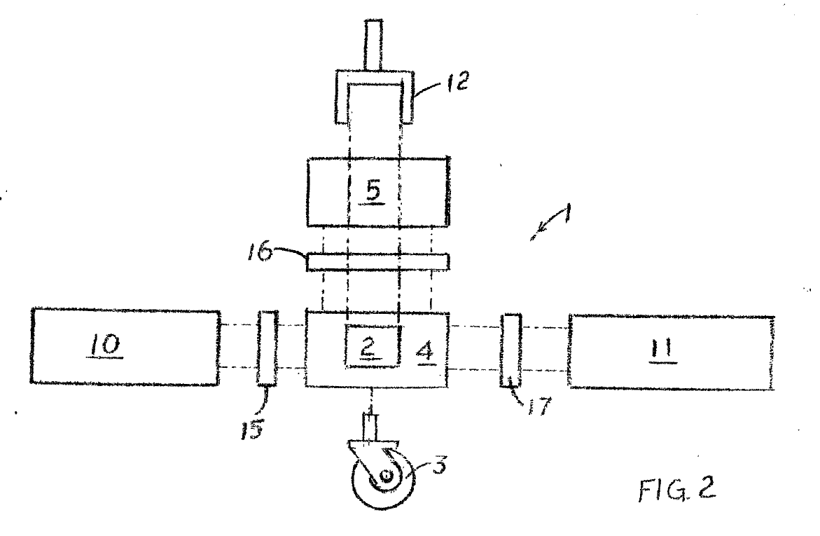

Referring now to FIGS. 1 through 3. Wheeled platform 1 is configured to be strong, versatile and low cost. Beam 2 is provided with wheel receivers 13 for wheels such as caster wheel 3. Wheels of various sizes and types may be attached to the platform of this invention by means of receivers 13 to form wheeled platform 1. For example, if the machine assembled on platform 1 is to be towed on the highway, a set of wheels that are suitable for highway towing can readily replace caster wheels 3.

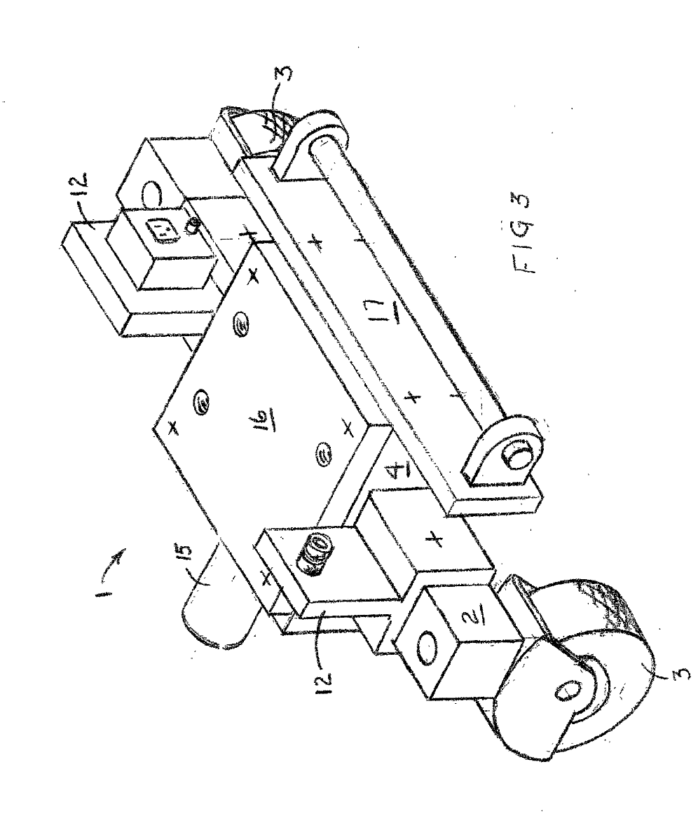

Platform 4, which is located in the midspan of beam 2 is provided with a means for securing thereto propulsion means interface 15, power source interface 16 and attachment interface 17. As shown in FIG. 3 interfaces 15, 16 and 17 are secured to mounting platform 4 by means of threaded fasteners 18. Interfaces 15, 16 and 17 are configured to be secured to mounting platform 4 and to have a means for coupling a specific component or components to platform 4 by way of interfaces 15, 16, and 17.

For example, snow blower attachment 6 of FIG. 1 is the task performing apparatus of the machine architecture of FIG. 1 and has as a part of its structure a rod 19 which in the architecture shown serves as a means for coupling snow blower 6 to interface 17 and also serves as an articulation means that permits the rotation of snow blower 6 in pitch relative to wheeled platform 1.

As another example, in FIG. 1, vehicle 7 has as a part of its structure bumper 9, and serves as the propulsion means 10 for the machine architecture of FIG. 1. Because snow blower 6 will be maneuvered in front of vehicle 7 the architecture of FIG. 1 provides a linkage 20 between bumper 9 and propulsion means interface 15 to place snow blower 6 where an operator can see it and guide it in operation. Linkage 20 has bumper clamp 21, pivots 22, A-frame 23 and longitudinal coupling pin 24 as a part thereof. Propulsion means interface 15 is provided with a receiver 25 for linking coupling pin 24 to propulsion means interface 15. This coupling provides an articulated coupling which permits wheeled platform 1 to rotate in roll about a horizontal longitudinal axis. Pivots 22 serve as an articulated coupling between A-frame 23 and bumper clamp 21 so as to permit A-frame 23 to rotate in pitch relative to propulsion means 10. It should be noted that in the configuration of FIG. 1, wheeled platform 1 is free to move in yaw on caster wheels 3 with the turning of propulsion means 10.

As yet another example of the functions of interfaces in this invention, power source interface 16 is securable to platform 4 and has as a part thereof treaded means which are positioned to match the mounting holes on engine 8 so as to permit the fixed mounting of engine 8 onto platform 4.

To complete the functional architecture of the machine assembled on wheeled platform 1, a power transmission means 31, here shown as a belt 32, transmits power from engine 8 to snow blower 6.

The above disclosures would enable one skilled in the art to make and use this invention for its intended purposes. The inventor has a duty to disclose the best mode of practicing the invention known to him at the time of filing of this patent application.

In many of the applications for this invention there is a need for connecting the components of the architecture built upon the wheeled platform of this invention with power, utilities, control signals, and the like. To serve those and similar needs it is within the scope of this invention to provide utility mounts 12 as shown in FIGS. 1, 2 and 3 Utility mounts 12 are shown in FIG. 3 to have as a part thereof, electrical outlet 35, electronic coupling 36, hydraulic coupling 37 and cable guide 38. Utility mounts 12 can be configured for a specific architecture and be replaced by a new mount 12 to serve a different architecture at a low cost.

The inventor has disclosed a typical task performing machine assembled upon the wheeled platform of his invention. He has disclosed a large representative sample of the components that can be interfaced with the wheeled platform of his invention to develop machine architectures. He has disclosed the best mode of practicing his invention known to him at the time for preparing this patent application. He has shown and taught much that is in the prior art in order to clearly define what he regards as his invention.

To disclose all of the prior art components that could be interfaced with the wheeled platform of this invention would greatly multiply the drawings and cause the specifications and claims to become prolix.

Therefore, it should be understood that the scope of this invention should not be seen as coextensive with the above disclosures, but rather, the scope of this invention should only be limited by the scope of the appended claims and all equivalents thereto that would be made apparent thereby to one skilled in the art.

What is claimed is:

1. A wheeled platform for constructing a mobile task performing machine comprising:
a) an elongate beam having a first end and a second end and having secured to the mid-span of the beam a central platform,
b) a means for receiving and detachably securing wheels near the first and second ends of the beam,
c) a means for detachably securing components of a task performing machine to the platform and beam wherein,
1) at least one of the components is a propulsion means,
2) at least one of the components is a task performing apparatus, and
3) at least one of the components is a power source.

2. The wheeled platform of claim 1 wherein the means for securing components to the platform is an interface that is secureable to the platform and has a means for coupling a specific component to the interface.

3. The wheeled platform of claim 1 wherein the wheeled platform is provided with a means for coupling utilities and controls that interconnect the components secured to the platform.

4. The wheeled platform of claim 1 wherein the propulsion means is selected from a group consisting of cars, tractors, riding mowers, golf carts, skid steerers, trucks, garden tractors, all terrain vehicles, and crawlers.

5. The wheeled platform of claim 1 wherein the power supply is selected from a group consisting of gasoline engines, hydraulic motors, diesel engines, pneumatic pumps, hydraulic pumps, electric motors, pneumatic motors, and generators.

6. The wheeled platform of claim 1 wherein the task performing apparatus is selected from a group consisting of mowers, tillers, trenchers, blades, shredders, saws, pumps, mulchers, edgers, snow blowers, rakes, sprayers, cycle bars, aerators, augers, sweepers chippers. splitters, culvert cleaners, generators, buckets, leaf blowers, scoops.

7. A wheeled platform for constructing a mobile task performing machine comprising:
a) an elongate beam having a first end and a second end and having secured to the mid-span of the beam a central platform,
b) a means for receiving and detachably securing wheels near the first and second ends of the beam,
c) a means for detachably securing components of a task performing machine to the platform and beam wherein,
1) at least one of the components is a propulsion means,
2) at least one of the components is a task performing apparatus, and
3) at least one of the components is a power source,
d) and, wherein the means for detachably securing components of a task performing machine is an interface securable to the central platform,
e) and, wherein the wheeled platform is provided with a means for coupling utilities and controls that interconnect the components secured to the platform.
